(19) United States
(12) Patent Application Publication
(10) Pub. No.: US 2021/0097876 A1
(43) Pub. Date: Apr. 1, 2021

(54) DETERMINATION OF TEST FORMAT BIAS

(71) Applicant: International Business Machines Corporation, Armonk, NY (US)

(72) Inventors: Cesar Augusto Rodriguez Bravo, Alajuela (CR); Jayashree Vaidyanathan, Cincinnati, OH (US); Craig M. Trim, Ventura, CA (US)

(21) Appl. No.: 16/583,310

(22) Filed: Sep. 26, 2019

(51) Int. Cl. G09B 7/00

(52) U.S. Cl. CPC G09B 7/00; G09B 7/02

(57) ABSTRACT

Technology for choosing a test format or a test taker based at least in part upon how well, and/or how poorly, that test-taker has performed on that test format in the past. Also, technology applicable to a situation where a test includes multiple portions in multiple different formats, where the different portions of the test are weighted differently depending upon how well, or how poorly, the test-taker as respectively performed on the multiple different formats in the past. Some embodiments of the present invention may increase test taker grades by aligning test format with the respective talents of various test takers. Other embodiments may decrease test-taker grades by weighting heavily grades on test portions in test formats unfavorable to the respective test-takers.

### BACKGROUND

The present invention relates generally to the field of testing of students (for example, adult students, child students, workers with testable skills).

Academia is rife with articles on the perils of standardized testing. The similarity between standardized tests and the “assembly line model,” effectively and places young students inside a one-fits-all educational mold and labels low-scoring students as failures. It is believed that scores of elementary school students on the common standardized tests is not increasing over time.

US patent application 20180130367 (“Rudolph”) discloses as follows: “A multi-layer user-selectable electronic testing (MUSET) system provides a cascaded set of alternative testing formats for test-takers to select a testing format that best accommodates their level of ability. Test-takers can answer fill-in-the-blank (FITB) items on a computer or other input device. If the test-taker is less confident of their understanding, they can select multiple-choice (MC) or true/false (T/F) testing formats. The MUSET system measures, tracks, and stores the amount of time it takes to answer test items, to switch testing formats, and to change answers. Test-takers indicate a confidence level that they have in the correctness of their answer. The MUSET system determines confidence characteristics, latency characteristics, and hesitancy characteristics of the test-taker and gathers additional parameters to build a performance profile of the test-taker's skills/traits/abilities. The performance profile is analyzed to guide and inform evaluators regarding individual performance, trends over time, differences between test-taker subsets, and analyses of test items.”

### SUMMARY

According to an aspect of the present invention, there is a method, computer program product and/or system that performs the following operations (not necessarily in the following order): (i) receiving a historical test score data set that includes information of: (a) a plurality of historic test scores respectively achieved by a first test-taker on a plurality of first-test-taker tests, and (b) for each given first-test-taker, a test format value from among a plurality of test formats for the given first-test-taker test; (ii) determining a first test format bias value for the first test-taker and with respect to a first test format of the plurality of formats based, at least in part, upon the historical test score data set, with the first test format bias value reflecting the favorability of the first test format relative to other test formats; and (iii) taking a responsive action based, at least in part, upon the first test format bias value.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a table helpful in understanding an embodiment of the present invention;

FIG. 6 is a table helpful in understanding an embodiment of the present invention;

FIG. 7 is a table helpful in understanding an embodiment of the present invention;

FIG. 8 is a screenshot view generated by a second embodiment of a system according to the present invention;

FIG. 9 is a screenshot view generated by a second embodiment of a system according to the present invention; and

FIG. 10 is a flowchart showing a second embodiment method performed, at least in part, by the second embodiment system.

### DETAILED DESCRIPTION

Some embodiments of the present invention are directed to choosing a test format or a test taker based at least in part upon how well, and/or how poorly, that test-taker has performed on that test format in the past. Some embodiments of the present invention are directed to test that include multiple portions in multiple different formats, where the different portions of the test are weighted differently depending upon how well, or how poorly, the test-taker as respectively performed on the multiple different formats in the past. Some embodiments of the present invention may increase test taker grades by aligning test format with the respective talents of various test takers. Other embodiments may decrease test-taker grades by weighting heavily grades on test portions in test formats unfavorable to the respective test-takers.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

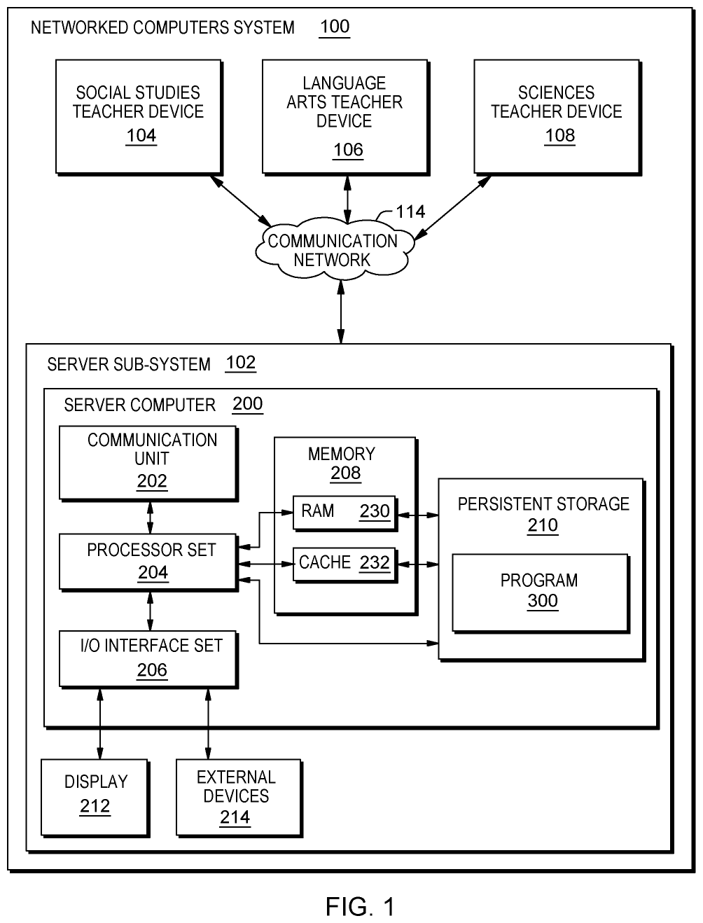

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); Social Studies teacher device 104; Language Arts teacher device 106; Sciences teacher device 108; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

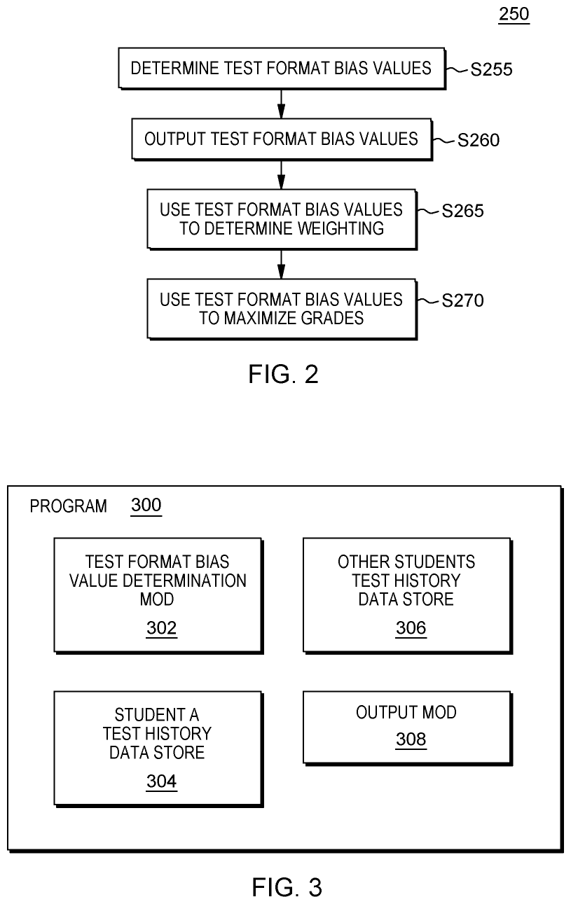

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation 5255, where the machine logic (for example software) of test format bias value determination module (“mod”) 302 determines two types of test format bias values for Student A: (i) essay format test format bias values (measured in +/−percentile units); and (ii) a multiple choice test format bias values (again, measured in +/−percentile units). Alternatively, or additionally, other test formats (now known or to be determined in the future) may be considered for test format bias. In this example, mod 302 only considers previous multiple choice and essay tests that Student A has taken (see Student A test history data store 304) in three subjects: Language Arts, Social Studies and Sciences. Alternatively, test bias format may be calculated without this level of subject matter granularity, or with greater subject matter granularity. Also, while this example only considers scoring of tests that Student A has actually taken, some embodiments may additionally, or alternatively, consider scores of tests that Student A has not taken, but that students with characteristics similar to Student A has taken (see other students' test history data store 306).

In this example, the test bias format scores for the three subject matter areas are determined in a mutually independent way (for example, performance on essay tests in Sciences will not affect determination of a test bias value for essay test in the Language Arts. Alternatively, the determinations may not be mutually independent, even if different test format bias values are ultimately determined for different subject matter areas. So, in this example, operation S255 will determine six (6) test format bias values for Student A as follows: (i) essay test format bias in Language Arts; (ii) multiple choice test format bias in Language Arts; (iii) essay test format bias in Social Studies; (iv) multiple choice test format bias in Social Studies; (v) essay test format bias in Sciences; and (vi) multiple choice test format bias in Sciences.

More specifically, in this example, Student A's Social Studies multiple choice test format bias value is determined as follows: (i) the difference between Student A's score and the the median student score on each Social Studies multiple choice test she has taken in the past is determined (these values are herein referred to as raw Social Studies multiple choice variations or RSSMCV values); (ii) each of the RSSMCV values are normalized against Student A's general performance in Social Studies for the year that each Social Studies multiple choice test was taken to obtain NSSMCV values (normalized Social Studies multiple choice variation values); (iii) each of the NSSMCV values is given a relative weight based, in this example, on the following factors: (a) how recent the test was, and (b) how important the test was relative to Student A's grade in the class; and (iv) a weighted average of the NSSMCV values is calculated to determine Student A's multiple choice test format bias for Social Studies. It is noted that various embodiments of the present invention may vary considerably from the specific calculation method of the previous example.

The six (6) test format bias values calculated for Student A are: (i) essay test format bias in Language Arts is +10 percentile points; (ii) multiple choice test format bias in Language Arts is −10 percentile points; (iii) essay test format bias in Social Studies is +5 percentile points; (iv) multiple choice test format bias in Social Studies is −5 percentile points; (v) essay test format bias in Sciences is 0 percentile points; and (vi) multiple choice test format bias in Sciences is 0 percentile points.

Processing proceeds to operation S260, where output mod 308 outputs the Language Arts test format bias values for Student A for Language Arts (+10 for essay and −10 for multiple choice) to Language Arts teacher device 106 over communication network 114. This communication is being made because, at operation S265, the Language Arts teacher is going to give Student A Language Arts test, and wants to use the test format bias numbers in determining how the test will be graded.

More specifically, in this example, the Language Arts teacher is going to give Student A a test with an essay section and also a multiple choice portion. Traditionally, the Language Arts teacher has given each section of the test equal weight in determining the grade—that is, traditionally, each section accounts for 50% of the total grade. However, because the Language Arts teacher now has access to the test format bias numbers, she believes that she can evaluate Student A more fairly by adjusting the relative weighting of the two test sections based on the test format bias values.

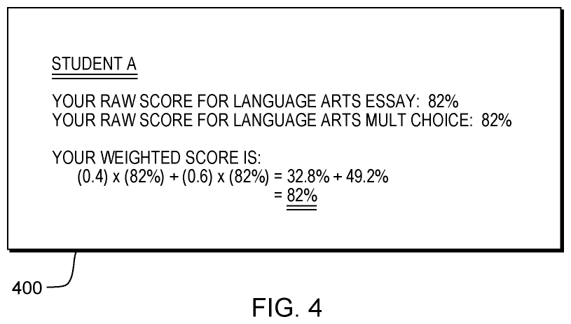

Even more specifically, the Language Arts teacher believes that test formats where the student is relatively weak provide a more realistic assessment of the student's degree of knowledge about and mastery of the subject matter being tested. For this reason, the Language Arts teacher will weight the two sections as follows: (i) the essay section (where Student A is relatively strong) will be worth 40% of the total grade; and (ii) the multiple choice section (where Student A is relatively weak) will be worth 60% of the total grade. In this example, the teacher lets Student A know about this individualized prospective weighting of test sections in advance so that Student A can adjust her study routine to work the hardest on multiple choice questions, which will be the majority of the basis of her eventual grade. Because Student A studies harder on multiple choice questions, her grades on the multiple choice section and the essay section turn out to be equal—in this example, both 82%—which means that Student A's grade on the test is 82% (see screen shot 400 of FIG. 4 to see the grade computations of this example in more detail).

Processing proceeds to operation S270, where output mod 308 outputs the Language Arts test format bias values for Student A for Social Studies (+5 for essay and −5 for multiple choice) to Social Studies teacher device 104 over communication network 114. This communication is being made because the Social Studies teacher is going to give Student A Social Studies test, and wants to use the test format bias numbers in determining what the format of the test should be for Student A. The school has instructed the Social Studies teacher that she should use any and all techniques, which are consistent with teaching ethics, to raise the grades of her students. Accordingly, the Social Studies teacher decides to give Student A an essay test, rather than a multiple choice test. The idea is that Student A will perform best on a test having a format that has been historically favorable to Student A. Student A scores a 98% on the essay test, and the Social Studies teacher's supervisors are quite pleased by this test score.

As may be mentioned in the following sub-section of this Detailed Description section, in some embodiments the format of a test and/or relative weighting of test sections may be performed by machine logic (such as software based artificial intelligence).

### III. Further Comments and/or Embodiments

Some embodiments of the present invention recognize the following facts, potential problems and/or potential areas for improvement with respect to the current state of the art: (i) an ideal improvement to the learning process creates an evaluation tailored to every student; (ii) a customized profile of skill and learning psychology can aid in this endeavor, but this is a complicated and time-consuming process; and/or (iii) worksheets and flashcards work well for students who absorb knowledge visually, but for children who need to hear the information in auditory to grasp it, traditional methods of teaching force them to use a physical sense that is not as well-developed.

Some embodiments of the present invention may include one, or more, of the following operations, features, characteristics and/or advantages: (i) customized learning experience for individual students; (ii) the application of novel statistical methods permits tailoring of a test to an individual student's learning psychology; (iii) provides a smart system that automatically takes the results of the students test to create a profile for each user based on her weak and strong areas regarding the testing methods (for example, Student B prefers multiple choice, while Student C prefers Essays or long answer questions); (iv) identifies the student strong/weak areas of learning (test) to create a profile that will be used to tailor future assignments; (v) enhances current teaching models by helping the teachers to identify the most effective test method for each student; and/or (vi) adapts the type of test that is administered to the student.

Some embodiments of the present invention may include one, or more, of the following operations, features, characteristics and/or advantages: (i) identifies student skills against different evaluation methods; (ii) some different types of evaluation methods may include: short answer, long answer, essays, multiple choice, smaller test/bigger test; (iii) creates a profile for each student that is intermittently updated based on student results and progress; (iv) discovery of patterns to improve the evaluation methods used; (v) determine the level of concentration of the student to determine the optimum length for tests (for example, some people have failed to obtain certifications not because they don't know the subject, but because they are not suitable for big test); (vi) identify those cases where a proper evaluation method will be key to help professionals in their careers; (vii) trigger of alerts in case the variance between test met a predetermined threshold; and/or (viii) recommendation engine (sorted by relevance and applicability).

Some embodiments of the present invention may include one, or more, of the following operations, features, characteristics and/or advantages: (i) can be integrated as part of larger artificial intelligence and/or machine learning systems; (ii) can be connected to pre-existing application program interfaces (APIs) like text to speech, speech to text and discovery services; (iii) can be used by schools, companies and/or certification bodies to increase their reach to a broader audience; (iv) assesses student skills based on the evaluation method used; (v) categorizes the assessments based on the evaluation method used; (vi) tracks student performance based on the evaluation method used; (vii) creates a user preference profile based on the grades obtained by evaluation method; (viii) displays the student's preferred evaluation method by subject; (ix) creates and displays a dashboard of the student's performance by evaluation method; (x) monitors a predetermined set of thresholds related to the results of a student on a given assessment category; (xi) provides recommendation regarding the best evaluation method based on the student's preference profile and results; (xii) identifies the optimal size (in terms of time and number of items) for a test for a given student/person; (xiii) helps discover learning patterns on students; (xiv) reduces student stress/anxiety by discovering the best evaluation method/style/type for a given student; and/or (xv) enhances current capabilities of Learning Management Software (LMS) to include additional features aimed to provide a more customized learning experience to the student to help the student achieve better grades.

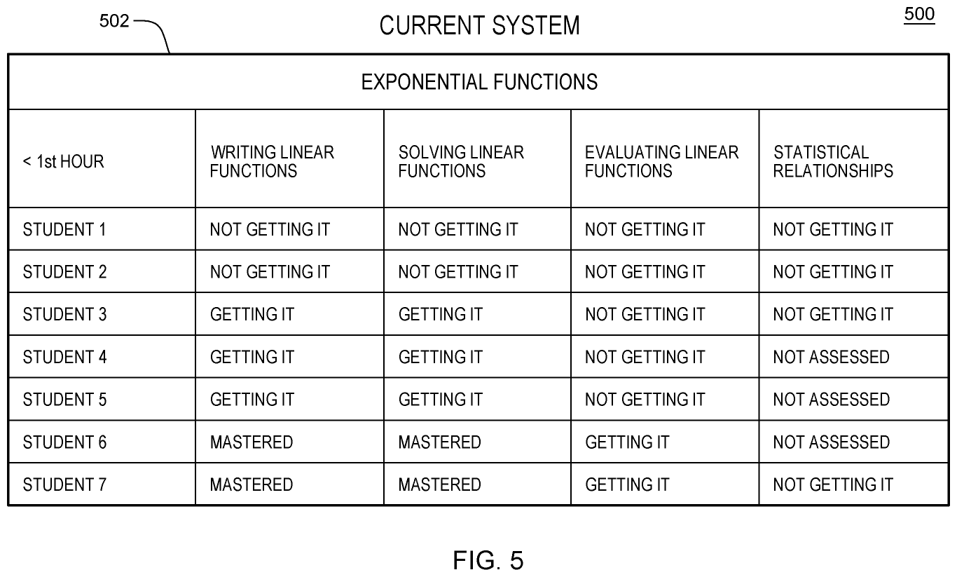

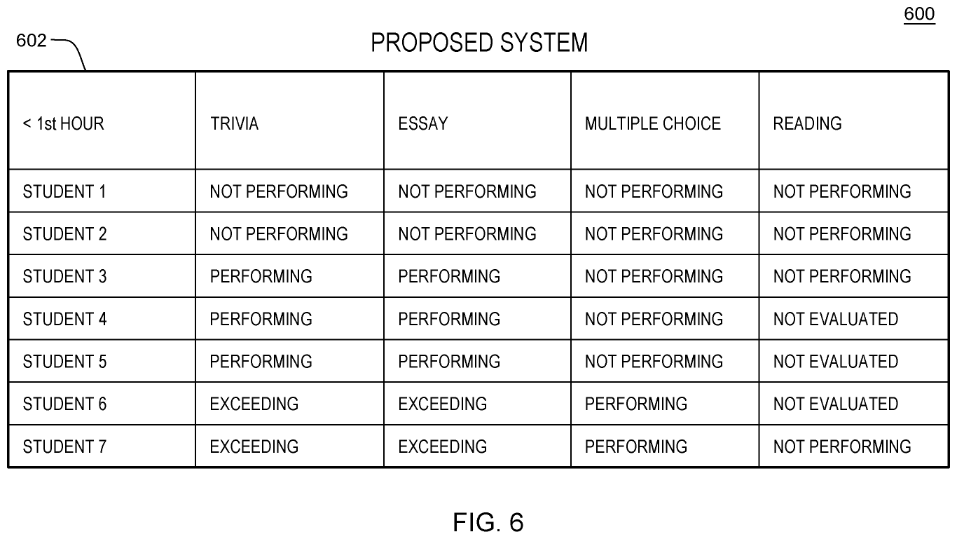

Some embodiments of the present invention may include one, or more, of the following operations, features, characteristics and/or advantages: (i) include a module where teachers manually rate students on a plurality of topics/subjects; and/or (ii) adding, the previous item on this list, the capability to assess the student skills on a given topic using a given evaluation method. As shown in FIG. 5, table 500 (including header row 502) shows that a teacher has manually rated 7 students with respect to 4 different mathematical skills. As shown in FIG. 6, table 600 (including first column 602) that shows some student profile data for each of the seven (7) students. More specifically, the student profile data indicates how well each of the students tends to perform on casts having one of 4 test formats as follows: trivia, essays, multiple choice, and reading.

As an example of what is discussed in the previous paragraph, consider the following: Student C is performing on math when questions are multiple choice but is under-performing when the questions are presented as a problem to solve; Student L is exceeding on Literature when doing essays, but is not performing in reading and comprehension.

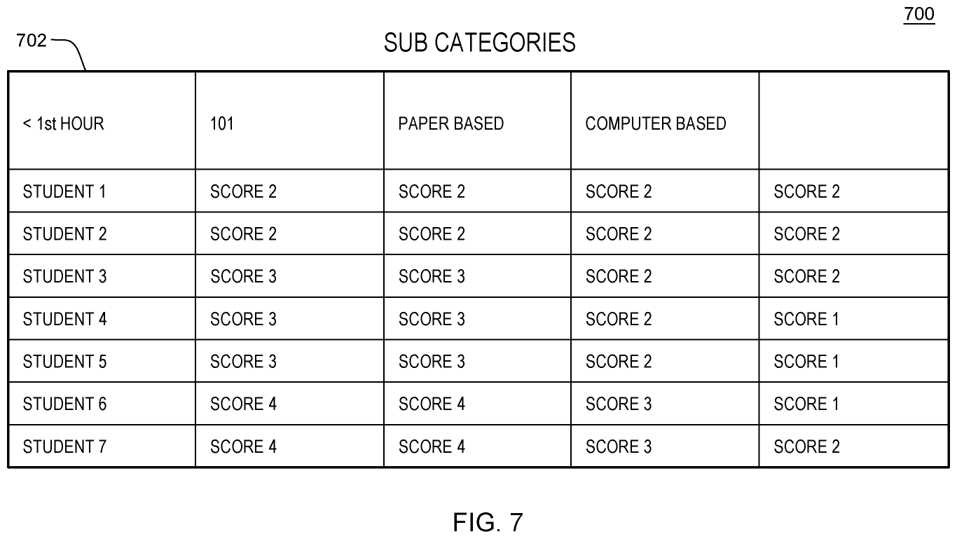

Some embodiments of the present invention may include one, or more, of the following operations, features, characteristics and/or advantages: (i) uses sub categories so the student can be rated on a plurality of levels (for example, in addition to the information above, some embodiments may also be able to check if the results are from computer based tests, paper based tests, one on one presentations, etc.); and/or (ii) enhances the level of details on the student profile which can be leveraged greatly by the teacher to improve the student's experience and grades. The use of subcategories is shown by table 700 (including first column 702) of FIG. 7.

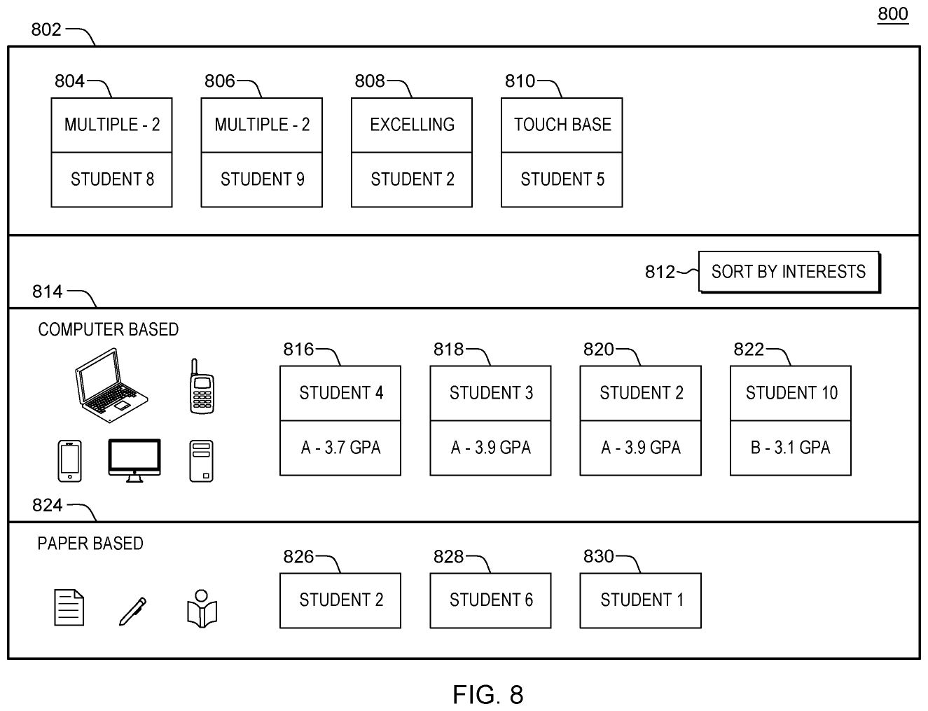

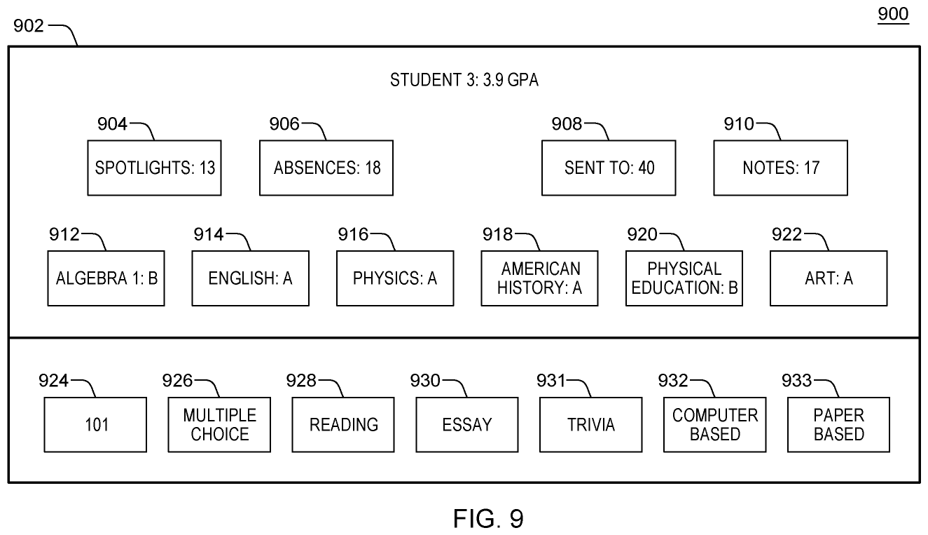

Some possible student preferences will now be discussed. Some embodiments may have a dashboard were teachers can quickly see the student's preferences to evaluate a given topic. This is potentially valuable for teachers when planning activities for the students to ensure the best experience/grade for each of them. An example of such a dashboard is shown by dashboard 900 of FIG. 9. A screen for selecting among and between different student dashboard displays is shown by dashboard 800 of FIG. 8. An embodiment of a student dashboard will now be discussed. The system may include a student dashboard that enables the teachers to get all the information regarding the student evaluation preferences on a single screen. There the teacher will be able to see how the student is performing on each subject on a given type of evaluation (computer based, essays, multiple choice, etc.).

Dashboard 800 includes: top display band 802; student 8 status block 804; student 9 status block 806; student 2 status block 808; student 5 status block 810; sort by interests button 812; computer based learning display band 814; student 4 grade block 816; student 3 grade block 818; student 2 grade block 820; student 10 grade block 822; paper based display band 824; student 2 block 826; student 6 block 828; and student 1 block 830.

Dashboard 900 includes: top display band 902; student 3 educational statistics blocks 904, 906, 908, 910, 912, 914, 916, 918, 920 and 922; and evaluation method blocks 924, 926, 928, 930, 931, 932 and 933.

Some embodiments of the present invention may include one, or more, of the following operations, features, characteristics and/or advantages: (i) the system receives the result of the student evaluation; (ii) the result contains all metadata available about the student and the evaluation; (iii) the evaluation results will be received from a plurality of sources (for example, Learning Management Systems (LMS), School/College Data bases, Advanced Educational Suits, Manually enter, Scanned (using OCR), Custom Data bases); (iv) the system will identify if the user is new, and, if the user is new, then the system will create a new record; (v) the system identifies the category, and, if new, the system will create a new category; (vi) the system will check if the subject is new, and, if yes, the system will create a new subject; (vii) the system updates the user profile based on evaluation results and categories; and/or (viii) the system checks for patterns that may be used by the teacher to improve the evaluation/class.

As an example of what is discussed in the previous paragraph consider the following example: (i) 80% of the students fail computer based evaluation done after 3 pm (this will allow the teacher to avoid this kind of evaluation after 3 pm and replace it with another activity); (ii) 75% of the kids improved their grades in math when using evaluation based on game trivia (this will allow the teacher to promote this kind of evaluation to improve the grades of the class); and (iii) the system will have a set of thresholds that can be setup by the teacher to trigger alerts in case that a condition is met, such as the following conditions: (a) if a Student drops his grades on a given category by more than 25%, (b) if a Student drops his grades on a given Sub-category by more than 25%, (c) if a student increased his grades more than 20% on a given category, (d) if a student increased his grades more than 20% on a given Sub-category, and (e) if the difference between the grades on a given par of categories is higher than 40%; (iv) the system provides recommendations based on the patterns discovered; (v) the recommendations can be gathered from internet or from an internal data base; (vi) the recommendations will be based on a scoring system that will be used to determine which suggestion is more relevant or more likely to work; (vii) the score is adjusted based on the feedback provided by the teacher depending on the results of the applied suggestion; and (viii) the system presents all the data using a plurality of dashboards for ease of review.

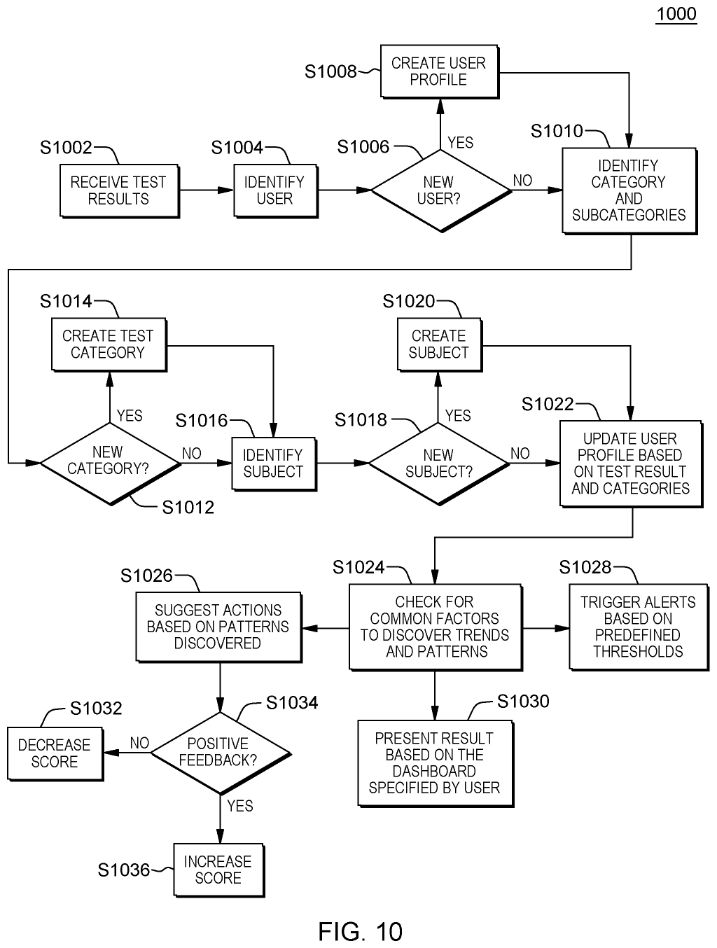

As shown in FIG. 10, flowchart 1000 shows a method according to the present invention including the following steps (with process flow among and between the steps being as shown by arrows in FIG. 10): S1002; S1004; S1006; S1008; S1010; S1012; S1014; S1016; S1018; S1020; S1022; S1024; S1026; S1028; S1030; S1032; S1034; and S1036.

Some embodiments of the present invention may include one, or more, of the following operations, features, characteristics and/or advantages: (i) based upon the user native ability to deal with a specific type of test methodology (for example, essay, problems, use cases, simulations, short answers); (ii) identify the user's natural skills when facing each evaluation method (trivia, essay, reading); (iii) based on evaluation methods of any kind which may involve interactions between the user (learned) and a physical method like reading a book (physical book), creating an essay (written by hand), making a test in paper, etc.); (iv) not limited to just virtual interactions but to any evaluation method used by the learner (physical or virtual); (v) categorization of assessments based on the evaluation method used; (vi) tracking of student performance based on the evaluation method used; (vii) creates a user preference profile based on the grades obtained by evaluation method; (viii) monitoring of a predetermined set of thresholds related to the results of a student on a given assessment category; and/or (ix) recommending the best evaluation method based on the student's preference profile and results.

Some embodiments of the present invention may include one, or more, of the following operations, features, characteristics and/or advantages: (i) identifies student performance on a plurality of methods to demonstrate knowledge and provide recommendations about which may be the best method to demonstrate that acquired knowledge on each different topic; (ii) involves “learning style” as the user natural (and preferred) method for learning (note that “learning style” is also sometimes referred to as a “test format”); (iii) identify/discover which learning style (or, test format) is the user's preferred method, which will enable the teacher to create a personalized education environment for the student; (iv) based on user performance on multiple historical tests; and/or (v) identifies a plurality of learning styles including: (a) Paper Based versus Computer Based; (b) Multiple Choice versus Essays; and/or (c) Reading versus trivia.

Some embodiments of the present invention may include one, or more, of the following operations, features, characteristics and/or advantages: (i) not merely related to computer based type of assessments, but can't consider any type of test, including paper based test (in which the result will be an input to the system); (ii) does not consider the amount of time the test-taker took to answer a question; (iii) a method based on the final result and other environmental factors that may affect the student like temperature, hour of the day (previous and next activities, etc.); (iv) identifies the best learning method so the teacher can provide the next test to the student based on that type of learning method, reducing the risk of making multiple tests that no one will use; (v) uses technology to analyze the results to better understand the preferred learning method for each student, on each subject, and on a given topic to provide the test using the best method for the student; (vi) methods that do not add additional work for the teacher; (vii) methods that reduce the workload to the teacher; (viii) analyzes multiple test methods like paper based versus computer based; and/or (ix) can test if a given student prefers paper based training or computer-based training.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a historical test score data set that includes information of: (i) a plurality of historic test scores respectively achieved by a first test-taker on a plurality of first-test-taker tests, and (ii) for each given first-test-taker, a test format value from among a plurality of test formats for the given first-test-taker test;
determining a first test format bias value for the first test-taker and with respect to a first test format of the plurality of formats based, at least in part, upon the historical test score data set, with the first test format bias value reflecting the favorability of the first test format relative to other test formats; and
taking a responsive action based, at least in part, upon the first test format bias value.

2. The CIM of claim 1 wherein the plurality of test formats include essay format and multiple choice format.

3. The CIM of claim 1 wherein the historical test score data set further includes: (i) a plurality of historic test scores respectively achieved by test-takers with characteristics similar to the first test taker on a plurality of non-first-test-taker tests, and (ii) for each given non-first-test-taker, a test format value from among a plurality of test formats for the given non-first-test-taker test.

4. The CIM of claim 1 wherein the responsive action includes the following operation:
checking for common factors to discover a first trend.

5. The CIM of claim 1 wherein the responsive action includes the following operation:
checking for common factors to discover a first pattern.

6. The CIM of claim 5 wherein the responsive action further includes at least one of the following three operations:
testing a first action based on the discovery of the first pattern;
presenting an indication of the discovery of the first pattern on a dashboard configured by the user; and
based on a predefined threshold.

7. A computer program product (CPP) comprising:
a storage device including a set of storage medium(s); and
computer code stored on the storage medium(s), with the computer code including data and instructions to cause a processor(s) set to perform at least the following operations:
receiving a historical test score data set that includes information of: (i) a plurality of historic test scores respectively achieved by a first test-taker on a plurality of first-test-taker tests, and (ii) for each given first-test-taker, a test format value from among a plurality of test formats for the given first-test-taker test,
determining a first test format bias value for the first test-taker and with respect to a first test format of the plurality of formats based, at least in part, upon the historical test score data set, with the first test format bias value reflecting the favorability of the first test format relative to other test formats, and
taking a responsive action based, at least in part, upon the first test format bias value.

8. The CPP of claim 7 wherein the plurality of test formats include essay format and multiple choice format.

9. The CPP of claim 7 wherein the historical test score data set further includes: (i) a plurality of historic test scores respectively achieved by test-takers with characteristics similar to the first test taker on a plurality of non-first-test-taker tests, and (ii) for each given non-first-test-taker, a test format value from among a plurality of test formats for the given non-first-test-taker test.

10. The CPP of claim 7 wherein the responsive action includes the following operation:
checking for common factors to discover a first trend.

11. The CPP of claim 7 wherein the responsive action includes the following operation:
checking for common factors to discover a first pattern.

12. The CPP of claim 11 wherein the responsive action further includes at least one of the following three operations:
testing a first action based on the discovery of the first pattern;
presenting an indication of the discovery of the first pattern on a dashboard configured by the user; and
based on a predefined threshold.

13. A computer system (CS) comprising:
a processor(s) set;
a storage device including a set of storage medium(s); and
computer code stored on the storage medium(s), with the computer code including data and instructions to cause the processor(s) set to perform at least the following operations:
receiving a historical test score data set that includes information of: (i) a plurality of historic test scores respectively achieved by a first test-taker on a plurality of first-test-taker tests, and (ii) for each given first-test-taker, a test format value from among a plurality of test formats for the given first-test-taker test,
determining a first test format bias value for the first test-taker and with respect to a first test format of the plurality of formats based, at least in part, upon the historical test score data set, with the first test format bias value reflecting the favorability of the first test format relative to other test formats, and
taking a responsive action based, at least in part, upon the first test format bias value.

14. The CS of claim 13 wherein the plurality of test formats include essay format and multiple choice format.

15. The CS of claim 13 wherein the historical test score data set further includes: (i) a plurality of historic test scores respectively achieved by test-takers with characteristics similar to the first test taker on a plurality of non-first-test-taker tests, and (ii) for each given non-first-test-taker, a test format value from among a plurality of test formats for the given non-first-test-taker test.

16. The CS of claim 13 wherein the computer code further includes data and instructions to cause a processor(s) set to perform at least the following operation(s):
generating a dashboard display of a student profile for the first test-taker, with the dashboard display including the first test format bias value.

17. The CS of claim 13 wherein the responsive action includes the following operation:
checking for common factors to discover a first trend.

18. The CS of claim 13 wherein the responsive action includes the following operation:
checking for common factors to discover a first pattern.

19. The CS of claim 18 wherein the responsive action further includes at least one of the following three operations:
testing a first action based on the discovery of the first pattern;
presenting an indication of the discovery of the first pattern on a dashboard configured by the user; and
based on a predefined threshold.
